(19) United States
(12) Patent Application Publication
(10) Pub. No.: US 2008/0027883 A1
(43) Pub. Date: Jan. 31, 2008

(54) UTILITIES PROVISION SYSTEM AND METHOD

(75) Inventors: Koovashni Reddy, Stanhope Gardens (AU); Mirko Zeljko, Albion (AU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: EARTH UTILITY PTY LTD, Stanmore Gardens (AU)

(21) Appl. No.: 11/770,434

(22) Filed: Jun. 28, 2007

(30) Foreign Application Priority Data
Jul. 25, 2006 (AU) 2006904005

(51) Int. Cl. G06Q 10/00

(52) U.S. Cl. 705/400

(57) ABSTRACT

A system 10 for providing a utility 12 comprises a plurality of utilities 12, at least one utility to be installed in each of a plurality of premises 14. The system 10 includes a database 16 of data relating to the utility 12 to be installed, the data including data relating to funding for purchasing the utility 12 and a term of a contract with a customer for whom the utility 12 is installed. A processor 18 is in communication with the database 16 to use the data to determine a service fee 20 to be charged by a supplier to a customer for use of the utility 12, the service fee 20 being determined independently of energy usage.

### RELATED APPLICATION

The present application claims priority from Australian Provisional Patent Application No 2006904005 filed on 25 Jul. 2006, the contents of which are incorporated herein by reference.

### BACKGROUND

1. Field

This invention relates, generally, to the provision of utilities. More particularly, the invention relates to a system for, and a method of, providing a utility to a customer. The invention relates particularly to the provision of a utility using renewable energy resources but is not necessarily exclusively related to such applications.

2. General Background

At present, most premises use either gas or electricity to heat water for the provision of hot water in the premises. As is well known, fossil fuels are generally used in the generation of electricity and gas with the resultant negative consequences for the environment.

In particular, households require a cheap reliable source of hot water. Increasing numbers of households are becoming more environmentally aware and would like to use renewable energy resources for the provision of utilities. A convenient way of enabling households to be more environmentally aware, particularly in countries with large periods of sunshine, is with the provision of solar panels for heating of water. For ease of explanation, the solar heating of water will be referred to below as a “solar hot water system”.

Additionally, photovoltaic systems can be used as a power source for the premises with excess energy being able to be sold by the householder into a power supply grid.

Unfortunately, solar hot water systems and photovoltaic systems are expensive and beyond the budget of many households. Even conventional gas or electric hot water systems are expensive and, when requiring replacement, can create a serious financial burden for households.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to a first aspect of the invention, there is provided a system for providing a utility, the system comprising:

a plurality of utilities, at least one utility to be installed in each of a plurality of premises;

a database of data relating to the utility to be installed, the data including data relating to funding for purchasing the utility and a term of a contract with a customer for whom the utility is installed; and

a processor in communication with the database to use the data to determine a service fee to be charged by a supplier to a customer for use of the utility, the service fee being determined independently of energy usage.

The term “utility” is to be understood, unless the context clearly indicates otherwise, as relating to equipment that uses renewable resources to generate electrical energy which can then be used to heat water and/or provide power for premises. Therefore, the utility may be in the form of one of a solar hot water system, a photovoltaic system and a combination of the foregoing. Both such systems comprise a plurality of solar panels. In the case of the solar hot water system, the solar panels are used to heat water and the system includes a tank or a reservoir which is used to store the heated water. In the case of a photovoltaic system, the solar panels are used to supply electrical energy which may be stored in electrochemical storage devices, such as batteries, for a stand alone system or in the grid for a grid-connected system, the energy being used to provide power to premises.

It will be appreciated that, because the service fee is calculated independently of energy usage, there is no necessity to meter energy usage for the purpose of calculating the service fee. This, in the long term, provides benefits to the customer and to the provider of the utility since the infrastructure associated with metering can be omitted.

The service fee to be charged may be charged in advance per accounting period. For example, the service fee may be charged quarterly in advance. Further, the service fee may be determined on the basis that it increases by a certain multiple periodically. For example, the service fee may be determined to increase with the Consumer Price Index each year.

In addition, the service fee may be calculated based on a tariff, on a predetermined scale, normally charged by a utilities provider for electricity or gas consumption. Further, the service fee may change depending on the capital cost of the utility. This may be driven by the size, visual requirements, weather requirements, etc. of the utility. A further criterion in determining the service fee may be the value of green products earned as a result of installation of the utility. Green products are defined to include renewable energy certificates (RECs) and any other existing or future environmental products from schemes such as carbon taxes, emissions trading, electricity and gas or other energy distribution or transmission network payments, or other environmental rebates, grants, financial products or schemes to be proposed in the future.

The service fee may further be calculated based on the savings experienced by a typical premises occupier, for example, a household, switching from electricity or gas to provide energy under average conditions. By fixing the fee at an energy savings amount, solar energy is effectively priced equivalent to electrical or gas energy at a predefined rate and average consumption and is applied to all users of the system.

The system may include a booster system to provide booster energy in the event that the provided utility cannot cope with demand due to prevailing environmental circumstances, for example, where a large number of consecutive cloudy days occur.

Where booster energy is provided for the utility, the service fee may also take into account the booster energy type which is used, for example, gas or electric.

In the case of the utility being a grid-connected photovoltaic system, the system exports excess or surplus energy to the grid and imports additional energy required when the need arises, the energy being imported at a rate charged by the energy retailer. The customer pays the net of the energy imported less energy exported based on preset tariffs set by the energy retailer.

Preferably, the contract to be entered into with the customer remains with the customer who may, for example, be the owner of the premises.

The supplier is responsible for maintenance and repairs to the utility for the term of the contract including replacing the utility should it fail totally.

The system may include the provision of other resource saving devices. The resource saving devices may, for example, be water saving devices which are optionally provided with the utility further to enhance savings by the customer. The water saving devices may be given away at no charge or, if the supplier needs to finance the water saving devices, these may be provided at a charge to the customer.

According to a second aspect of the invention, there is provided a method of providing a utility, the method comprising:

providing a utility to a customer;

storing data relating to the utility to be installed, the data including data relating to funding for purchasing the utility and a term of a contract with the customer; and

determining a service fee to be charged by a supplier to the customer for use of the utility using the data stored in the database but independently of energy usage.

The method may include installing the utility at no charge to the customer.

Further, the method may include charging the service fee in advance per accounting period. The method may include determining the service fee on the basis that it increases by a certain multiple periodically.

The method may also include calculating the service fee based on a tariff, on a predetermined scale, normally charged by a utilities provider for electricity or gas consumption. Further, the method may include changing the service fee depending on the capital cost of the utility.

In addition, the method may include determining the service fee based on the value of green products earned as a result of installation of the utility. Still further, the method may include calculating the service fee based on the savings experienced by a premises occupier switching from electricity or gas to provide energy under average conditions.

The method may include providing a booster system to provide booster energy in the event that the provided utility cannot cope with demand due to prevailing environmental circumstances.

Where booster energy is provided for the utility, the method may include calculating the service fee to take into account the booster energy type which is used, for example, gas or electric.

The method may include structuring a contract to be entered into with the customer so that it remains with the customer.

Further, the method may include invoking predetermined termination provisions of the contract if the customer vacates the premises, for example, as a result of moving from, or selling, the premises. In addition, the method may include, invoking predetermined clauses of the contract regarding payment and security options if the customer does not pay when billed for the service fee, with removal of the utility being a last resort. The supplier may take security over the system or take a charge over the asset by placing a caveat to ensure that payment is made if the customer absconds.

The method of any one of claims 14 to 27 which includes charging the service fee by direct debit. If payment methods other than direct debit are employed, an additional fee may be charged.

The supplier may be responsible for maintenance and repairs to the utility for the term of the contract including replacing the utility should it fail totally.

The method may include providing other resource saving devices. The resource saving devices may, for example, be water saving devices which are optionally provided with the utility further to enhance savings by the customer. The method may include giving away the resource saving devices may be given away by the supplier at no charge.

### BRIEF DESCRIPTION OF DRAWINGS

An embodiment of the invention is now described by way of example with reference to the accompanying diagrammatic drawings in which:

FIG. 1 shows a schematic representation of a system, in accordance with an embodiment of the invention, for providing a utility;

FIG. 2 shows a flow chart of a part of a method, in accordance with an embodiment of the invention, for providing a utility; and

FIG. 3 shows a schematic representation of a part of a system, in accordance with another embodiment of the invention, for providing a utility.

### DETAILED DESCRIPTION OF EXEMPLARY EMBODIMENTS

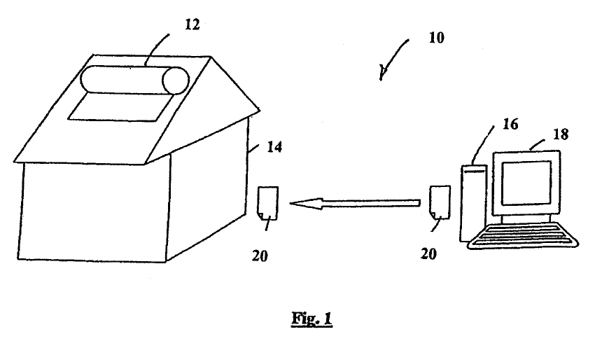

Referring initially to FIG. 1 of the drawings, reference numeral 10 generally designates a system, in accordance with an embodiment of the invention, for providing a utility. The system 10 includes a plurality of utilities, each in the form of a solar hot water system 12. One such system 12 is shown mounted on premises such as a customer's house 14. The embodiment will be described below with reference to its application to the provision of solar hot water systems 12. However, it will be appreciated that the system 10 is not exclusively applicable to renewable energy resources.

The system 10 includes a database 16. The database 16 contains data relating to the solar hot water system 12 to be installed. More particularly, the data includes data relating to funding costs associated with purchasing the solar hot water system 12, a term of a contract with a customer, etc.

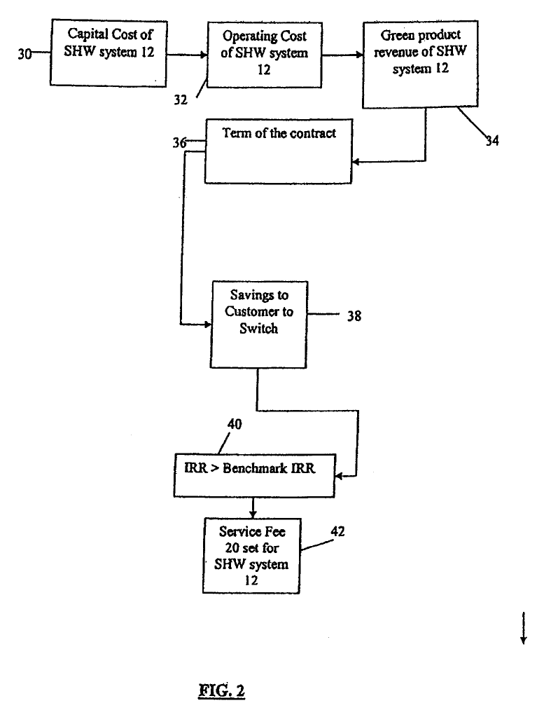

A processor 18 communicates with the database 16. The processor 18 uses the data to determine a service fee, represented schematically by invoice 20, to be charged to a customer for use of the solar hot water system 12, as will be described in greater detail below with reference to FIG. 2 of the drawings. The service fee 20 charged is independent of energy usage.

In use, a utilities provider, which may, for example, be an energy provider or an independent entity, purchases a plurality of the solar hot water systems 12 and then arranges for their installation in the premises 14 of customers who have signed up to the system 10. The cost associated with the solar hot water systems 12, the installation of the solar hot water systems 12 and the maintenance of the solar hot water systems 12 will be for the account of the provider. The customer will only be charged the service fee 20.

The service fee 20 is charged to the customer at predetermined accounting intervals such as, for example, quarterly in advance. Thus, the only charge applicable to the customer is the payment of the quarterly service charge. In addition, the service fee 20 may increase annually with CPI.

To reduce accounting complexity, the system 10 includes the requirement that the service charge be paid to the provider by direct debit. If the customer wishes to settle the payment of the service charge in a different manner, an additional fee may be applicable.

It is intended that the contract, or service agreement, between the supplier or provider of the utility and the customer will be for the life of the solar hot water system 12 or the term of the use of the solar hot water system 12 as governed by the contract.

Further, the agreement is between the provider and the owner of the premises 14. Where rental properties are involved, a billing arrangement may be made with the tenants but the service agreement remains between the owner of the premises 14 and the provider.

While it is intended that the service agreement is perpetual (ongoing) and will last for the term of use of the solar hot water system 12, if the customer moves home, two options will be available to the owner/customer (referred to as the “customer”). Firstly, the customer may elect to transfer the service to a new owner of the premises 14. If all parties, including the provider, are in agreement, the provider will facilitate transfer of the agreement to the new owner. The service will continue to be provided without interruption. On transfer of the agreement, the financial obligation will similarly be transferred to the new customer.

A second option is that the existing customer of the premises 14 will have the option to purchase the solar hot water system 12 from the provider. The price to be paid by the purchaser will be determined based on the wholesale purchase price and sunk installation costs. The price will be discounted according to the length of the time the solar hot water system 12 has been in operation.

As indicated above, the service fee 20 is charged independently of any energy usage by the customer at the premises 14. The service fee 20 is dependent on the cost of the system 12. In addition, the service fee 20 is determined based on current electric or gas hot water bill savings, based on the customer's energy usage tariff, to switch to solar energy, the cost of the system 12, the term of the service agreement between the customer and the provider, the costs associated with financing purchase of the systems 12 and returns to investors in the provider.

Insofar as current electric or gas hot water savings are concerned, it is intended that the customer will have a saving in switching to solar hot water usage in comparison with existing electricity or gas costs.

All solar hot water systems have backup, booster electrical or gas systems associated with them in the event that the solar hot water system is unable to meet demand. This may occur when there is an unseasonably long cloudy period or unseasonably cold weather resulting in reduced solar input. It is intended that the cost savings to the customer will be calculated by subtracting the costs to run the booster energy from the costs of running a conventional hot water system.

Other aspects which need to be factored into the cost of the service fee 20 are ongoing running costs such as repairs, maintenance and insurance. The service agreement provides that, as part of the service fee 20, the provider maintains the solar hot water system 12 for the duration of the service agreement which is the term of use of the system 12. The maintenance may include, at the provider's sole discretion, periodically replacing the solar hot water system 12 with an upgraded system as improvements in technology occur.

When a solar hot water system is installed, green products, in the form of a number of renewable energy certificates (RECs), are associated with each solar hot water system. These RECs can be traded to result in cost savings to a user of the solar hot water system 12. A typical solar hot water system 12 of a capacity of 300 litres can earn up to 34 RECs while a 400 litre unit can earn up to 44 RECs. The service fee 20 is determined based on a 300 litre unit with an upward revision for a 400 version unit based on the difference between the RECs earned by the two units. For other units, a similar calculation can be made. It will be understood the system 10 is intended to take into account other green products which may be created by legislation at a local, state, federal or internal level.

In determining the cost, installation fees need to be taken into account as well as penetration of the market. Assuming a 50% sales level of both systems, a 300 litre unit and 400 litre unit cost can be determined. As the uptake of the system 10 improves the cost calculation can be reconsidered.

In determining the term of the contract, the longer the term, the more beneficial the cost savings will be to the customer. As indicated above, the provider funds, owns, supplies, installs, maintains and insures the solar hot water system 12 for the life of the asset.

For example, it may be determined that the greatest benefit to the customer will be provided by having a term of the contract of 20 years. The provider monitors the market continually to assess the best contract term to offer to its customers based on other offerings, changes to technologies, reduced costs of production and improved volume discounts.

As indicated above, the service fee 20 includes a debt term for financing the system 12. This term is based on the life of the service agreement between the customer and the provider. Thus, for example, if a customer has a 5 year contract with the provider, the debt term will be a corresponding 5 year term. The longer the debt term (all other variables being the same), the higher the returns are to the investor.

The return to investor rate, or internal rate of return, is set at a benchmark level to ensure that investors earn a return commensurate with the risk taken. The service fee 20 is set to ensure that a benchmark rate of return is met.

The booster energy is provided by a conventional utilities provider. The booster energy is metered in the conventional fashion by the utilities provider and charged accordingly. It will be appreciated that a benefit of the use of a service fee calculated in the manner set out above is that it is independent of energy usage. Thus, no metering is required which results in substantial cost savings as no metering infrastructure is needed.

Another aspect of the system 10 is that water savings devices may, optionally, be distributed by the provider in a further effort to reduce energy consumption. The water savings devices may be given away free of charge or installed at a cost included in the service fee.

Referring now to FIG. 2 of the drawings, a flowchart of the determination of the service fee 20 is illustrated. At step 30, the capital cost of the solar hot water system 12 is computed. This is the cost to purchase and install the unit and may include other set up costs charged upfront rather than ongoing operating costs such as maintenance costs.

At step 32, the operating cost of the system 12 is computed. The operating cost includes a forecast of ongoing operating costs, debt and depreciation. At step 34, any revenue arising from green products are taken into account as a reduction in operating costs. At step 36, the term of the contract is factored in as a variable. This sets the basis of the term of the service agreement. However, at the end of the life of the system 12, a new system 12 may be installed and the service agreement continues.

As shown at step 38 a cost savings is provided for the customer to switch to the system 10 from a conventional electricity or gas supply.

Regardless of whether the contractual term is for the life of the solar hot water system 12 or not, the system 10 should provide an internal rate of return (IRR) greater than a benchmark IRR. The IRR is calculated on net cash flow post tax and fees over a period of at least 20 years, if not longer, and may change from time to time. The cash flows are the net business cash inflows and outflows. Thus, as shown at step 40, the service fee is computed based on the IRR being greater than a benchmark IRR. Finally, as shown at step 42, the service fee 20 is set.

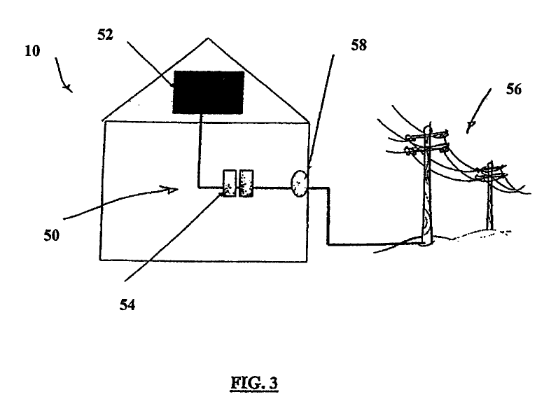

Referring to FIG. 3 of the drawings, a further embodiment of a system 10 for providing a utility is illustrated. With reference to the previous drawings. like reference numerals refer to like parts unless otherwise specified.

In this embodiment, the utility is a photovoltaic system 50. The photovoltaic system 50 comprises a plurality of solar panels 52 mounted on the premises 14. The solar panels 52 provide electrical energy to a conditioning circuit 54. Where the photovoltaic system 50 is a standalone unit, i.e. not connected to an electricity grid 56, the conditioning circuit includes electrochemical storage devices in the form of rechargeable batteries for storing electrical energy for later use. In the case where the photovoltaic system 50 is connected to the grid 56, the batteries may be omitted.

The photovoltaic system 50 includes a net meter 58. The net meter 58 is used to determine the amount of energy exported by the photovoltaic system 50 to the grid 56 or, instead, the amount of energy imported from the grid 56. It is emphasised the net meter 58 is not used to meter energy usage by the customer and does not affect the determination of the service fee 20 which is calculated independently of energy usage.

The provision of the photovoltaic system 50 is effected by the provider under the same terms and conditions as described above with reference to the solar hot water system 12 and the contract between the provider and the customer will be essentially the same as for the solar hot water system 12. A difference, however, in this embodiment is that the contract caters for fees earned as a result of exporting excess energy generated by the photovoltaic system 50 to the grid 56. The benefit of such income will be for the customer up to an agreed level and, anything in excess of the agreed level, will be shared between the provider and the customer based on an agreed pre-set formula based on historical usage, the kilowatt capacity installed, energy produced, energy used by the customer from the grid 56 and a regulated tariff charged by a local utilities provider.

Hence, it is an advantage of the invention that a system 10 and method are provided which enables a customer to switch to the use of a renewable energy resource such as solar energy. In particular, the system allows the customer, in most circumstances, to obtain a cost saving while using a renewable energy resource.

Due to the fact that the service fee is calculated independently of energy usage, there is no metering required. Thus, there are cost savings associated with the obviating of the need for a metering infrastructure. These costs savings can be substantial as, apart from the hardware, there is no requirement for meter readers periodically to call on customers to determine energy usage.

With the provision of the system 10 and method, a customer is able to use a solar hot water system 12, which is an expensive resource, on an affordable basis with certainty as to the ongoing costs for use of the system 10. In the case of the photovoltaic system 50, there is the added advantage that the customer and, possibly, the provider can derive income from supplying excess energy to the grid 56.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for providing a utility, the system comprising:
a plurality of utilities, at least one utility to be installed in each of a plurality of premises;
a database of data relating to the utility to be installed, the data including data relating to funding for purchasing the utility and a term of a contract with a customer for whom the utility is installed; and
a processor in communication with the database to use the data to determine a service fee to be charged by a supplier to a customer for use of the utility, the service fee being determined independently of energy usage.

2. The system of claim 1 in which the utility is in the form of one of a solar hot water system, a photovoltaic system and a combination of the foregoing.

3. The system of claim 1 in which the service fee to be charged is charged in advance per accounting period.

4. The system of claim 1 in which the service fee is determined on the basis that it increases by a certain multiple periodically.

5. The system of claim 1 in which the service fee is calculated based on a tariff, on a predetermined scale, normally charged by a utilities provider for electricity or gas consumption.

6. The system of claim 1 in which the service fee changes depending on the capital cost of the utility.

7. The system of claim 1 in which a criterion in determining the service fee is the value of green products earned as a result of installation of the utility.

8. The system of claim 1 in which the service fee is calculated based on the savings experienced by a premises occupier switching from electricity or gas to provide energy under average conditions.

9. The system of claim 1 which includes a booster system to provide booster energy in the event that the provided utility cannot cope with demand due to prevailing environmental circumstances.

10. The system of claim 9 in which the service fee also takes into account the booster energy type which is used.

11. The system of claim 1 in which the contract to be entered into with the customer remains with the customer.

12. The system of claim 11 in which the supplier is responsible for maintenance and repairs to the utility for the term of the contract including replacing the utility should it fail totally.

13. The system of claim 1 which includes the provision of other resource saving devices.

14. A method of providing a utility, the method comprising:
providing a utility to a customer;
storing data relating to the utility to be installed, the data including data relating to funding for purchasing the utility and a term of a contract with the customer; and
determining a service fee to be charged by a supplier to the customer for use of the utility using the data stored in the database but independently of energy usage.

15. The method of claim 14 which includes installing the utility at no charge to the customer.

16. The method of claim 14 which includes charging the service fee in advance per accounting period.

17. The method of claim 14 which includes determining the service fee on the basis that it increases by a certain multiple periodically.

18. The method of claim 14 which includes calculating the service fee based on a tariff, on a predetermined scale, normally charged by a utilities provider for electricity or gas consumption.

19. The method of claim 14 which includes changing the service fee depending on the capital cost of the utility.

20. The method of claim 14 which includes determining the service fee based on the value of green products earned as a result of installation of the utility.

21. The method of claim 14 which includes calculating the service fee based on the savings experienced by a premises occupier switching from electricity or gas to provide energy under average conditions.

22. The method of claim 14 which includes providing a booster system to provide booster energy in the event that the provided utility cannot cope with demand due to prevailing environmental circumstances.

23. The method of claim 22 which includes calculating the service fee to take into account the booster energy type which is used.

24. The method of claim 14 which includes structuring a contract to be entered into with the customer so that it remains with the customer.

25. The method of claim 24 which includes invoking predetermined termination provisions of the contract if the customer vacates the premises, for example, as a result of moving from, or selling, the premises.

26. The method of claim 24 includes invoking predetermined clauses of the contract regarding payment and security options if the customer does not pay when billed for the service fee, with removal of the utility being a last resort.

27. The method of claim 14 which includes charging the service fee by direct debit.

28. The method of claim 24 in which the supplier is responsible for maintenance and repairs to the utility for the term of the contract including replacing the utility should it fail totally.

29. The method of claim 14 which includes providing other resource saving devices.

30. The method of claim 29 which includes giving away the resource saving devices may be given away by the supplier at no charge.
